(19) United States
(12) Patent Application Publication
(10) Pub. No.: US 2008/0073905 A1
(43) Pub. Date: Mar. 27, 2008

(54) Pipe coupling system

(76) Inventor: Thomas Kilpatrick McLaughlin, Aberdeenshire (GB)

Correspondence Address: Guy McClung, #114, 5315-B F.M.1960 Rd. West, Houston, TX, 77069-4410, US

(21) Appl. No.: 11/528,702

(22) Filed: Sep. 27, 2006

(51) Int. Cl. F16L 15/04

(52) U.S. Cl. 285/55

(57) ABSTRACT

A tubular coupling system and method; the system and method in at least certain aspects, using a coupling member with an interior protective ring that has at least one inner energizing member which, upon compression, forces the body of the coupling member against an interior wall of the coupling thereby inhibiting corrosive material from contacting the coupling's interior wall or, in the event some corrosive material does enter this area, holding the interior protective ring against the coupling's interior wall so that the corrosive material may not exit this area, thus inhibiting or preventing a continuous flow of corrosive material.

### BACKGROUND OF THE INVENTION

1. Field of the Invention

The present invention is directed to tubular coupling structures; protection rings for such structures; in one particular aspect, to combinations of a pipe coupling, a protective interior ring, and two pieces of pipe coupled together by the coupling; and to corrosion-resistant threaded connection parts and assemblies for use with clad or lined tubulars, e.g., but not limited to, oil and gas well tubing and casing, piping in chemical and other plants, oil and gas pipelines, and the like.

2. Description of Related Art

Many tubulars are used to convey corrosive or erosive materials. Many piping systems and pipelines transport fluids that are highly corrosive to the carbon steel used in the pipe. In the drilling for and the production and injection of oil and gas, corrosion-resistant alloy pipe, e.g., casing or tubing, is now used in the drilling of oil and gas wells into zones that produce highly corrosive fluids. To overcome corrosion problems, and as well known to those skilled in the art, it is common to use lined steel pipe, with liners made of plastic, stainless steel, or other corrosion-resistant materials.

Certain typical multiple-walled pipe, e.g., a lined steel pipe, is a dual or double-walled pipe in which the inner wall is a liner tube made of a corrosion-resistant material that serves as a conductor for the corrosive fluid, and an outer wall or pipe that is designed to provide strength to withstand the internal pressures of the corrosive fluid, as well as external forces such as external pressure, mechanical loading, etc. In certain tubulars, there are limitations on the length of such double-walled pipes due to conditions to which the pipes are subjected on site. Thus, in the case of tubing or casing strings and in the production of oil and gas, each joint of pipe is usually about 24-44 feet long while the tubing or casing string itself may be thousands of feet long. Accordingly, and as is well known in making up such tubing or casing strings, successive joints of tubing/casing are connected together using couplings until the desired length of string is achieved. Similarly in pipelines successive pieces of pipe are joined by couplings.

It is desirable, where successive joints of the lined or clad pipe are joined to one another by means of a coupling that the interior of the coupling is protected from corrosion. Many prior art coupling and seal systems attempt an effective coupling structure e.g., and not by way of limitation, as disclosed in the subject matter of U.S. Pat. Nos. 590,811; 1,909,075; 2,040,786; 2,233,734; 2,805,872; 4,679,831; 5,282,652; 5,470,111; 5,689,871; 6,312,024; 6,863,313; and U.S. application Ser. No. 10/513,213 filed May 5, 2003, all of which patents are incorporated fully herein for all purposes.

### BRIEF SUMMARY OF THE INVENTION

The present invention discloses, in certain embodiments, a tubular coupling system with a coupling member and an interior protective ring that has at least one inner energizing member which, upon compression, forces the body of the coupling member against the interior wall of the coupling thereby inhibiting corrosive material from contacting the coupling,s interior wall or, in the event some corrosive material does enter this area, the interior protective ring is held against the coupling's interior wall so that the corrosive material, once present, may not exit this area, thus preventing a continuous flow of corrosive material into and out of this area.

In certain aspects, such a protective ring has two or more energizing members; and in one particular aspect such a ring has three spaced-apart energizing members located in recesses adjacent openings in the ring that provide for controlled compression of the ring and holding of the ring in position with respect to the coupling's interior wall.

Accordingly, the present invention includes features and advantages which are believed to enable it to advance coupling technology. Characteristics and advantages of the present invention described above and additional features and benefits will be readily apparent to those skilled in the art upon consideration of the following detailed description of preferred embodiments and referring to the accompanying drawings.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures. It is, therefore, an object of at least certain preferred embodiments of the present invention to provide:

New, useful, unique, efficient, non-obvious coupling systems for tubulars that convey corrosive or erosive material;.

Such systems and methods that employ an inner protective ring with one or more energizing members which, upon compression, assist in holding the ring in place; and

Such systems and methods that use such a ring that has edges trapped between a coupling member and an end of a tubular to assist in maintaining a desired location of the ring.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWING

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or equivalent embodiments.

FIG. 1A is a side cross-section view of a coupling system according to the present invention.

FIG. 1B is a top view of part of the system of FIG. 1A.

FIG. 1C is a top view of part of the system of FIG. 1A.

FIG. 2A is a side cross-section view of a coupling system according to the present invention.

FIG. 2B is a side view in cross-section of part of the system of FIG. 2A.

FIG. 2C is a side view in cross-section of part of the system of FIG. 2A.

FIG. 2D is a side view in cross-section of part of the system of FIG. 2A.

FIG. 2E presents a cross-section view of various energizing members according to the present invention.

FIG. 3A is a partial side view in cross-section of a protective ring according to the present invention.

FIG. 3B is a partial side view in cross-section of the protective ring of FIG. 3A installed in a coupling member according to the present invention.

FIG. 3C is a partial side view in cross-section of the protective ring of FIG. 3A and the coupling member of FIG. 3B in initial compression.

FIG. 3D is a partial side view in cross-section of the protective ring of FIG. 3A and the coupling member of FIG. 3B in further compression.

FIG. 3E is a partial side view in cross-section of the protective ring of FIG. 3A and the coupling member of FIG. 3B compressed while the coupling connects two tubulars.

Presently preferred embodiments of the invention are shown in the above-identified figures and described in detail below. It should be understood that the appended drawings and description herein are of preferred embodiments and are not intended to limit the invention or the appended claims. On the contrary, the intention is to cover all modifications, equivalents and alternatives falling within the spirit and scope of the invention as defined by the appended claims. In showing and describing the preferred embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiment, and are not intended to mean the claimed invention of any particular appended claim(s) or all of the appended claims. Accordingly, the subject or topic of each such reference is not automatically or necessarily part of, or required by, any particular claim(s) merely because of such reference.

### DETAILED DESCRIPTION OF THE INVENTION

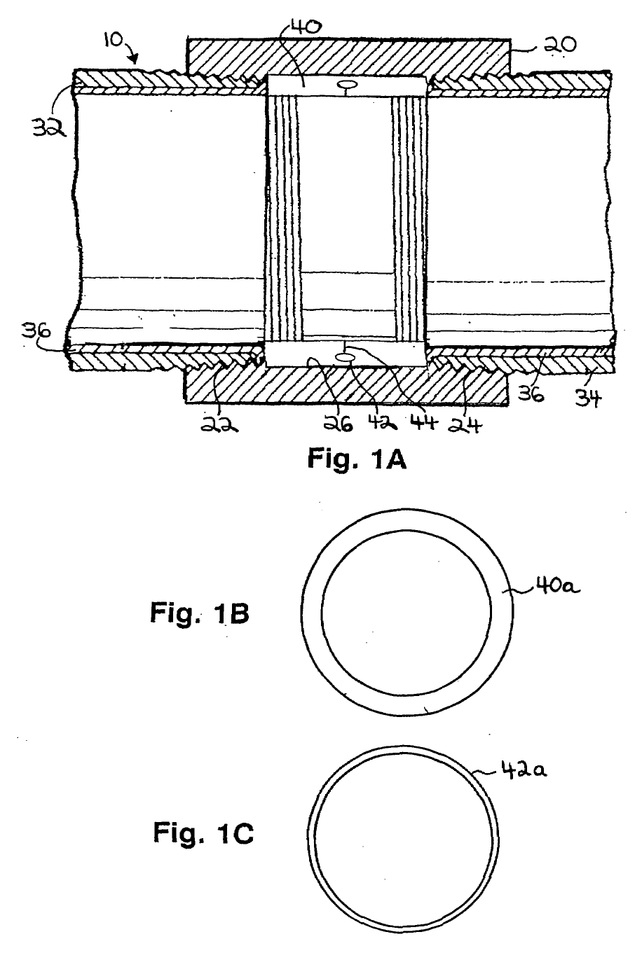

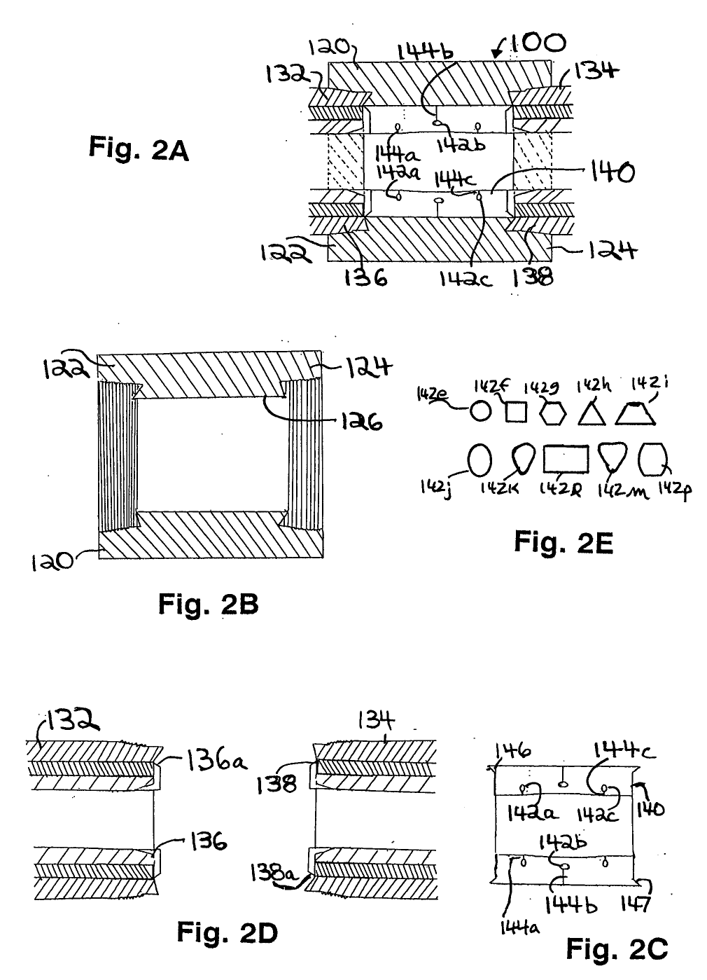

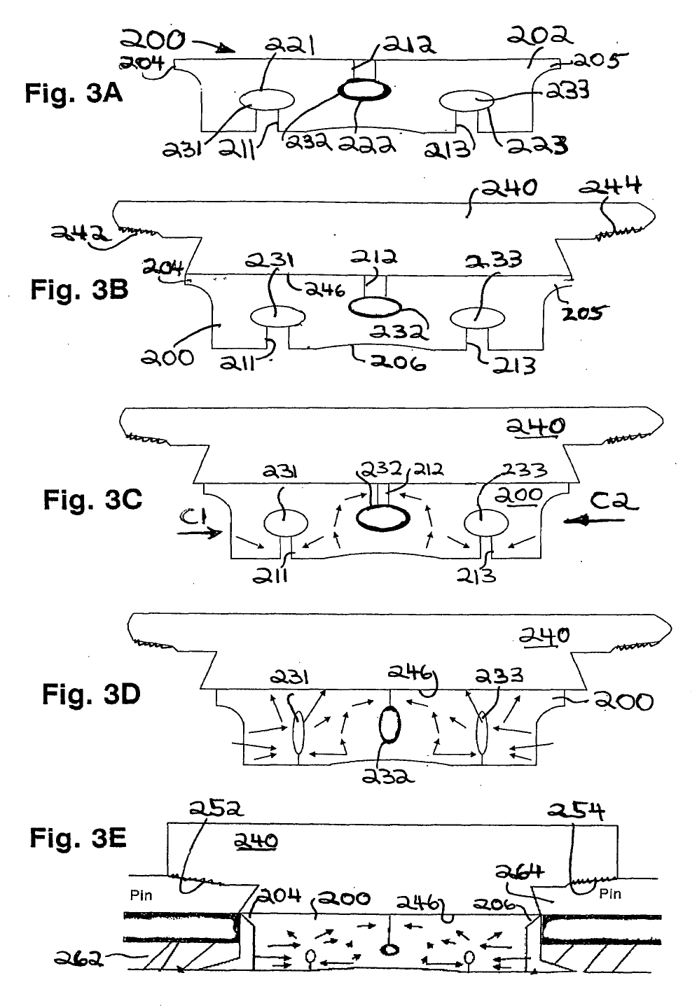

As shown in FIG. 1A, a coupling system 10 according to the present invention has a coupling member 20 which is a generally cylindrical hollow member with interiorly threaded spaced-apart ends 22, 24 and an interior wall 26. Two tubulars 32, 34 are threadedly connected to respective ends 22, 24 of the coupling member. Between ends of the two tubulars 32, 34 and adjacent the interior wall 26 of the coupling member 20 is a ring 40 (shown schematically) which is any ring according to the present invention. Optionally the tubulars 32, 34 have a liner 36 which may be any known tubular liner. Optionally, the ring 40 has one, two, three, four or more (one shown) energizing member 42. Optionally, a recess, slit, or opening 44 (or recesses or openings) (all referred to as “openings”) lead from an exterior of the ring 40 to the energizing member(s) 42 which allow movement (e.g. axial movement of the ring) without a change in volume of the ring. FIG. 1B is a top (or bottom) view of one embodiments 40a of a ring 40. FIG. 1C is a top (or bottom) view of one embodiment 42a of a ring 42. The rings and energizing members of FIGS. 2A, 2E and 3A are, similarly, items which are generally circular.

As shown in FIGS. 2A-2D, a coupling system 100 according to the present invention has a protective ring 140 according to the present invention held in compression between the pin ends 136, 138 of the pipes 132, 134. Each pin end 136, 138 is threadedly secured in a respective end 122, 124 of a coupling member 120. The protective ring 140 has three spaced-apart openings 144a, 144b, and 144c, each of which extends interiorly from an exterior of the ring 140 and extends to an interior space which contains an energizing member 142a, 142b, 142c, respectively. Any energizing member in any embodiment of the present invention may have any suitable cross-section shape, including but not limited to, those shown in FIG. 2E (shapes as follows: 142e, circular; 142f, square; 142g, hexagonal; 142h, triangular; 142i, trapezoidal; 142j, oval; 142k, teardrop; 142l, rectangular; 142m, teardrop; 142p, barrel).

Each pin end 136, 138 has an outer end bevel or taper 136a, 138a, respectively. Edge portions 146, 147 of the protective ring 140 are squeezed between an interior wall 126 of the coupling member 120 and the bevelled pin ends, thus assisting in securing the ring 140 in place adjacent the interior wall 126 of the coupling member 120.

It is within the scope of the present invention for all energizing members of a ring according to the present invention to be of the same or of different hardness. As shown in FIG. 2A, the two energizing members 142a, 142c are of the same hardness and the energizing member 142b is of a material harder than the material of the energizing members 142a, 142c. In one particular aspect, the energizing members 142a, 142c are made of a resilient elastomeric material, e.g., but not limited to, nitrile or butile; in certain aspects the members 142a, 142c with a hardness of about 70 durometer and the member 142b with a hardness of about 90 durometer.

In the coupling system 100, the protective ring 140 extends around the entire inner circumference of the coupling member 120 and the energizing members 142a, 142b, and 142c (and their corresponding openings 144a, 144b, 144c) extend around (and within) the entire circumference of the ring 140.

FIG. 3A shows a protective ring 200 according to the present invention (e.g. usable in the coupling systems of FIGS. 1A and 2A). In certain particular aspects a body 202 of the ring 200 is made of compressible anti-corrosive material, e.g. elastomeric resilient material, polytetrafluoroethylene (“PTFE”), or a combination of elastomer and PTFE. Initially three openings 211, 212, and 213 extend from an exterior of the ring 200 to interior spaces 221, 222, 223, respectively, within the ring 200. Energizing members 231, 232, 233 are located within the interior spaces 221, 222, 223, respectively.

Optionally, the ring 200 has outer edges or “teeth” 204, 205.

The openings 211, 212, 213, the spaces 221, 222, 223 and the energizing members 231, 232, 233 extend around the entire generally cylindrical body 202 (which is like the rings 40 and 140 in general hollow cylindrical shape although only part of the ring 200 is shown in FIG. 3A). Optionally, the body 202 has a circumferential indentation 206 therearound.

As shown in FIG. 3B, the ring 200 is positioned adjacent and installed inside a coupling member 240 (shown partially—shaped generally cylindrically as the coupling members 20 and 120 described above) having internally threaded ends 242, 244 for threadedly mating with externally threaded ends (e.g. the ends 252, 254 of pipes 262, 264, FIG. 3E).

As shown in FIG. 3C the ring 200 is being compressed (indicated by arrows C1, C2), e.g. by pin ends of two tubulars to be connected together by the coupling 240. Since energizing members 231 and 233 are not as hard as the energizing member 232, the energizing members 231 and 233 move under compression before the energizing member 232, thus the ring 200 begins to move outwardly (toward the coupling member 240 as shown in FIG. 3C). The openings 211 and 213 begin to restrict and close. Then the opening 212 begins to restrict and close. The openings 211-213 provide space so that the ring 200 does not significantly expand into the flow path of the coupling member 240. The indentation 206 also facilitates the outward movement of the ring 200 and provides an area or a void for material to flow to when the ring is compressing.

FIG. 3D illustrates the ring 200 fully compressed with the openings 211-213 closed and the energizing members 231-233 compressed (the members 231-233 have changed shape). The ring 200 has been forced against an interior wall 246 of the coupling member and, due to the openings 211-213, the indentation 206, and/or the entrapment of the two teeth 204, 205, the ring 200 has been biased outwardly and prevented from bowing inwardly so that the ring 200 is pressed up against the interior wall 246 along the length of the ring 200. The energizing members 231-233 are pushing the ring 200 against the coupling's interior wall.

As shown in FIG. 3E, the edges or teeth 204, 205 of the ring 200 have been trapped between tapered ends of the tubulars 262, 264 and part of the interior wall 246 of the coupling member 240, thus facilitating maintenance of the ring 200 in position to protect the interior wall 246.

With no adhesive or material between the interior wall 246 and the ring 200, and with the edges 204, 205 entrapped as described, either: corrosive fluid and/or material does not come into contact with the wall 246; or once such fluid and/or material does move between the wall 246 and the exterior of the ring 200 it is held there and its escape therefrom is inhibited or prevented. Thus, the wall 246 is exposed only to that amount of the material (and, in certain aspects only to the amount of oxygen in that amount of material) so that other corrosive material is prevented from flowing into that space to corrode the wall 246.

In certain aspects oil country tubular goods are made according to certain length tolerances, e.g. one-eighth inch plus or minus. By approximately sizing the openings (e.g. the openings 211-213) of a ring according to the present invention, this manufacturing tolerance can be accommodated. For example, for tubulars with a one-eighth inch manufacturing tolerance, if each opening (e.g. 211-213) is 0.66 inches for a total of about 0.200 inches (actually 0.198 inches) and the energizing members themselves (e.g. members 231-233) can be squeezed a total of another 0.050 inches, a total of about 0.250 inches of compression is available, i.e., an amount equal to about the manufacturing tolerance of one-eighth inch plus or minus (a total of one-fourth inch).

The present invention, therefore, in at least certain (but not necessarily all) embodiments, provides systems for coupling together two tubulars, the systems including: a coupling member with a coupling body, the coupling body being generally cylindrical and having a channel therethrough, the coupling body with two spaced-apart ends, each end threaded for threaded mating with a tubular so that the coupling member is connectible to two tubulars, the coupling body having a central portion, the central portion having an interior wall; a ring positioned adjacent the interior wall of the central portion of the coupling body between the two spaced-apart ends of the coupling body and located for contact by the two tubulars by abutment by an end of each tubular, the ring being generally cylindrical and having a ring channel therethrough, the ring having a volume; at least one energizing member within the ring; and at least one opening leading through the ring to the at least one energizing member. Such systems may have one or some (in any possible combination) of the following: the at least one energizing member is three spaced-apart energizing members; the at least one opening is three openings, one opening corresponding to each energizing member; the three openings are a first opening, a second opening, and a third opening and each of both the first opening and the third opening extend from an interior of the ring to a corresponding energizing member, and the second opening extends from an exterior of the ring to a corresponding energizing member; the two tubulars having tapered portions and the ring having a first end and a second end and the ring having two spaced-apart outer edges, one at the first end of the ring and one at the second end of the ring, each outer edge trappable between an interior portion of the coupling member and a tapered portion of a tubular; the three spaced-apart energizing members are a first energizing member, a second energizing member, and a third energizing member, and each of said energizing members has a hardness, and the hardness of the second energizing member greater than the hardness of the first and third energizing members; the at least one energizing member is made of a resilient elastomeric material; the ring is made of compressible anti-corrosive material; the ring has a circumferential indentation therearound; the at least one opening is of sufficient size that the ring does not expand significantly into the ring channel upon installation within the coupling member and contact by the two tubulars; the ring, upon compression, is movable against the interior wall of the central portion of the coupling body by action of the at least one energizing member; and/or the at least one opening is sized for accommodating manufacturing length tolerances of the two tubulars.

The present invention, therefore, in at least certain (but not necessarily all) embodiments, provides a system for coupling together two tubulars, the system including: a coupling member with a coupling body, the coupling body being generally cylindrical and having a channel therethrough, the coupling body with two spaced-apart ends, each end threaded for threaded mating with a tubular so that the coupling member is connectible to two tubulars, the coupling body having a central portion, the central portion having an interior wall; a ring positioned adjacent the interior wall of the central portion of the coupling body between the two spaced-apart ends of the coupling body and located for contact by the two tubulars by abutment by an end of each tubular, the ring being generally cylindrical and having a ring channel therethrough, the ring having a volume; three spaced-apart energizing members within the ring; three openings, one opening corresponding to each energizing member, each opening leading through the ring to an energizing member; the three openings comprising a first opening, a second opening, and a third opening; each of both the first opening and the third opening extending from an interior of the ring to a corresponding energizing member; the second opening extending from an exterior of the ring to a corresponding energizing member; the three spaced-apart energizing members comprising a first energizing member, a second energizing member, and a third energizing member, and each of said energizing members having a hardness; the hardness of the second energizing member greater than the hardness of the first and third energizing members; and wherein the ring, upon compression, is movable against the interior wall of the central portion of the coupling body by action of the energizing members.

The present invention, therefore, in at least certain (but not necessarily all) embodiments, provides a method for coupling together two tubulars comprising a first tubular and a second tubular, the first tubular having an end with exterior threading, the second tubular having an end with exterior threading, the method including: threadedly engaging each threaded end of the each of the two tubulars with an end of two spaced-apart ends of a coupling system, the coupling system comprising a coupling member with a coupling body, the coupling body being generally cylindrical and having a channel therethrough, the coupling body with two spaced-apart ends, each end threaded for threaded mating with a tubular so that the coupling member is connectible to two tubulars, the coupling body having a central portion, the central portion having an interior wall, a ring positioned adjacent the interior wall of the central portion of the coupling body between the two spaced-apart ends of the coupling body and located for contact by the two tubulars by abutment by an end of each tubular, the ring being generally cylindrical and having a ring channel therethrough, the ring having a volume, at least one energizing member within the ring, and at least one opening leading through the ring to the at least one energizing member; an end of each tubular contacting the ring and compressing the ring; said compression energizing the at least one energizing member to move the ring against the interior wall of the central portion of the coupling body. Such a method may include one or some (in any possible combination) of the following: the at least one energizing member comprising three spaced-apart energizing members, wherein the at least one opening comprises three openings, one opening corresponding to each energizing member, wherein the three openings comprise a first opening, a second opening, and a third opening and each of both the first opening and the third opening extend from an interior of the ring to a corresponding energizing member, and the second opening extends from an exterior of the ring to a corresponding energizing member; the ring having two spaced-apart outer edges, one at the first end of the ring and one at the second end of the ring, and each outer edge trappable between an interior portion of the coupling member and tapered portions of the two tubulars, the method including trapping each outer edge between the interior portion of the coupling member and a tapered portion of one of the two tubulars; the three spaced-apart energizing members comprise a first energizing member, a second energizing member, and a third energizing member, and each of said energizing members has a hardness, the hardness of the second energizing member greater than the hardness of the first and third energizing members, the method including initiating energizing of the first and third energizing members before initiating energizing of the second energizing member; the at least one opening is of sufficient size that the ring does not expand significantly into the ring channel upon installation within the coupling member and contact by the two tubulars, the method including expanding the ring so that an insignificant amount of the ring expands into the ring channel; and/or the at least one opening is sized for accommodating manufacturing length tolerances of the two tubulars, the method including accommodating the manufacturing length tolerances with the at least one opening.

The present invention, therefore, in at least certain (but not necessarily all) embodiments, provides a method for coupling together two tubulars comprising a first tubular and a second tubular, the first tubular having an end with exterior threading, the second tubular having an end with exterior threading, the method including threadedly engaging each threaded end of the each of the two tubulars with an end of two spaced-apart ends of a coupling system, the coupling system comprising a coupling member with a coupling body, the coupling body being generally cylindrical and having a channel therethrough, the coupling body with two spaced-apart ends, each end threaded for threaded mating with a tubular so that the coupling member is connectible to two tubulars, the coupling body having a central portion, the central portion having an interior wall, a ring positioned adjacent the interior wall of the central portion of the coupling body between the two spaced-apart ends of the coupling body and located for contact by the two tubulars by abutment by an end of each tubular, the ring being generally cylindrical and having a ring channel therethrough, the ring having a volume, at least one energizing member within the ring, and at least one opening leading through the ring to the at least one energizing member; an end of each tubular contacting the ring and compressing the ring; said compression energizing the at least one energizing member to move the ring against the interior wall of the central portion of the coupling body; the at least one energizing member comprising three spaced-apart energizing members; wherein the at least one opening comprises three openings, one opening corresponding to each energizing member; wherein the three openings comprise a first opening, a second opening, and a third opening; each of both the first opening and the third opening extend from an interior of the ring to a corresponding energizing member; the second opening extends from an exterior of the ring to a corresponding energizing member; wherein the three spaced-apart energizing members comprise a first energizing member, a second energizing member, and a third energizing member, and each of said energizing members has a hardness, the hardness of the second energizing member greater than the hardness of the first and third energizing members; the method including initiating energizing of the first and third energizing members before initiating energizing of the second energizing member.

Accordingly, while preferred embodiments of this invention have been shown and described, many variations, modifications and/or changes of the system, apparatus and methods of the present invention, such as in the components, details of construction and operation, arrangement of parts and/or methods of use, are possible, contemplated by the patentee, within the scope of the appended claims, and may be made and used by one of ordinary skill in the art without departing from the spirit or teachings of the invention and scope of appended claims. Thus, all matter herein set forth or shown in the accompanying drawings should be interpreted as illustrative and not limiting, and the scope of the invention and the appended claims is not limited to the embodiments described and shown herein.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with all of the requirements of 35 U.S.C. §112. The inventors may rely on the Doctrine of Equivalents to determine and assess the scope of their invention and of the claims that follow as they may pertain to apparatus not materially departing from, but outside of, the literal scope of the invention as set forth in the following claims. All patents and applications identified herein are incorporated fully herein for all purposes.

What is claimed is:

1. A system for coupling together two tubulars, the system comprising
a coupling member with a coupling body, the coupling body being generally cylindrical and having a channel therethrough, the coupling body with two spaced-apart ends, each end threaded for threaded mating with a tubular so that the coupling member is connectible to two tubulars, the coupling body having a central portion, the central portion having an interior wall,
a ring positioned adjacent the interior wall of the central portion of the coupling body between the two spaced-apart ends of the coupling body and located for contact by the two tubulars by abutment by an end of each tubular, the ring being generally cylindrical and having a ring channel therethrough, the ring having a volume,
at least one energizing member within the ring, and
at least one opening leading through the ring to the at least one energizing member, said at least one opening facilitating maintenance position of the ring.

2. The system of claim 1 further comprising
the at least one energizing member comprising three spaced-apart energizing members.

3. The system of claim 2 wherein the at least one opening comprises three openings, one opening corresponding to each energizing member.

4. The system of claim 3 wherein the three openings comprise a first opening, a second opening, and a third opening and
each of both the first opening and the third opening extend from an interior of the ring to a corresponding energizing member, and
the second opening extends from an exterior of the ring to a corresponding energizing member.

5. The system of claim 1 wherein the two tubulars have tapered portions and the ring has a first end and a second end and further comprises
two spaced-apart outer edges, one at the first end of the ring and one at the second end of the ring, and
each outer edge trappable between an interior portion of the coupling member and a tapered portion of a tubular.

6. The system of claim 4 wherein
the three spaced-apart energizing members comprise a first energizing member, a second energizing member, and a third energizing member, and each of said energizing members has a hardness, and
the hardness of the second energizing member greater than the hardness of the first and third energizing members.

7. The system of claim 1 wherein the at least one energizing member is made of a resilient elastomeric material.

8. The system of claim 1 wherein the ring is made of compressible anti-corrosive material.

9. The system of claim 1 wherein the ring has a circumferential indentation therearound.

10. The system of claim 1 wherein the at least one opening is of sufficient size that the ring does not expand significantly into the ring channel upon installation within the coupling member and contact by the two tubulars.

11. The system of claim 1 wherein the ring, upon compression, is movable against the interior wall of the central portion of the coupling body by action of the at least one energizing member.

12. The system of claim 1 wherein the at least one opening is sized for accommodating manufacturing length tolerances of the two tubulars.

13. A system for coupling together two tubulars, the system comprising
a coupling member with a coupling body, the coupling body being generally cylindrical and having a channel therethrough, the coupling body with two spaced-apart ends, each end threaded for threaded mating with a tubular so that the coupling member is connectible to two tubulars, the coupling body having a central portion, the central portion having an interior wall,
a ring positioned adjacent the interior wall of the central portion of the coupling body between the two spaced-apart ends of the coupling body and located for contact by the two tubulars by abutment by an end of each tubular, the ring being generally cylindrical and having a ring channel therethrough, the ring having a volume,
three spaced-apart energizing members within the ring,
three openings, one opening corresponding to each energizing member, each opening leading through the ring to an energizing member,
the three openings comprising a first opening, a second opening, and a third opening,
each of both the first opening and the third opening extending from an interior of the ring to a corresponding energizing member,
the second opening extending from an exterior of the ring to a corresponding energizing member,
the three spaced-apart energizing members comprising a first energizing member, a second energizing member, and a third energizing member, and each of said energizing members having a hardness,
the hardness of the second energizing member greater than the hardness of the first and third energizing members, and
wherein the ring, upon compression, is movable against the interior wall of the central portion of the coupling body by action of the energizing members.

14. A method for coupling together two tubulars comprising a first tubular and a second tubular, the first tubular having an end with exterior threading, the second tubular having an end with exterior threading, the method comprising
threadedly engaging each threaded end of the each of the two tubulars with an end of two spaced-apart ends of a coupling system, the coupling system comprising a coupling member with a coupling body, the coupling body being generally cylindrical and having a channel therethrough, the coupling body with two spaced-apart ends, each end threaded for threaded mating with a tubular so that the coupling member is connectible to two tubulars, the coupling body having a central portion, the central portion having an interior wall, a ring positioned adjacent the interior wall of the central portion of the coupling body between the two spaced-apart ends of the coupling body and located for contact by the two tubulars by abutment by an end of each tubular, the ring being generally cylindrical and having a ring channel therethrough, the ring having a volume, at least one energizing member within the ring, and at least one opening leading through the ring to the at least one energizing member,
an end of each tubular contacting the ring and compressing the ring, and
said compression energizing the at least one energizing member to move the ring against the interior wall of the central portion of the coupling body.

15. The method of claim 14 wherein
the at least one energizing member comprising three spaced-apart energizing members,
wherein the at least one opening comprises three openings, one opening corresponding to each energizing member,
wherein the three openings comprise a first opening, a second opening, and a third opening and
each of both the first opening and the third opening extend from an interior of the ring to a corresponding energizing member, and
the second opening extends from an exterior of the ring to a corresponding energizing member.

16. The method of claim 14 wherein the ring has two spaced-apart outer edges, one at the first end of the ring and one at the second end of the ring, and each outer edge trappable between an interior portion of the coupling member and tapered portions of the two tubulars, the method including
trapping each outer edge between the interior portion of the coupling member and a tapered portion of one of the two tubulars.

17. The method of claim 14 wherein the three spaced-apart energizing members comprise a first energizing member, a second energizing member, and a third energizing member, and each of said energizing members has a hardness, the hardness of the second energizing member greater than the hardness of the first and third energizing members, the method including
initiating energizing of the first and third energizing members before initiating energizing of the second energizing member.

18. The method of claim 14 wherein the at least one opening is of sufficient size that the ring does not expand significantly into the ring channel upon installation within the coupling member and contact by the two tubulars, the method including
expanding the ring so that an insignificant amount of the ring expands into the ring channel.

19. The method of claim 14 wherein the at least one opening is sized for accommodating manufacturing length tolerances of the two tubulars, the method including
accommodating the manufacturing length tolerances with the at least one opening.

20. (canceled)
